(19) United States
(12) Patent Application Publication
(10) Pub. No.: US 2024/0112686 A1
(43) Pub. Date: Apr. 4, 2024

(54) CONFERENCING SESSION QUALITY MONITORING

(71) Applicant: Microsoft Technology Licensing, LLC, Redmond, WA (US)

(72) Inventor: Ross Garrett CUTLER, Clyde Hill, WA (US)

(73) Assignee: Microsoft Technology Licensing, LLC, Redmond, WA (US)

(21) Appl. No.: 17/976,467

(22) Filed: Oct. 28, 2022

Related U.S. Application Data
(60) Provisional application No. 63/411,426, filed on Sep. 29, 2022.

(51) Int. Cl. G10L 19/018

(52) U.S. Cl. CPC G10L 19/018

(57) ABSTRACT

A method for monitoring audio quality of a conferencing session between a plurality of participant devices is described. An audio receive channel and an audio send channel are established for a participant device. The participant device receives audio signals for the conferencing session on the audio receive channel and transmits audio signals on the audio send channel. A first audio signal is inserted into the audio receive channel for playback by the participant device. The first audio signal has an audio watermark. A second audio signal is received through the audio send channel, the second audio signal corresponding to a playback period of the first audio signal by the participant device. It is determined whether the audio watermark is present in the second audio signal. An audio status is provided for the participant device based on whether the audio watermark is present in the second audio signal.

### CROSS REFERENCES TO RELATED APPLICATIONS

This application claims the benefit of U.S. Provisional Patent Application No. 63/411,426, entitled “Conferencing Session Quality Monitoring,” filed on Sep. 29, 2022, which is hereby incorporated herein by reference in its entirety.

### BACKGROUND

There are many common challenges that affect individual and team productivity on conference calls. Some challenges affect those connected to audio-visual functionality, such as a video conference, where a user is speaking but not being heard by others or refers to slides that are not yet shown or shared. These challenges may occur due to external constraints on the system (e.g., low network bandwidth), user errors (e.g., accidental mute), or software bugs or other issues with communication software that host the video conference. There are also scenarios when a user simply wants to know whether they can be seen and/or heard, or whether other participants on a call can see their slides or their shared screen. Current approaches to handling these challenges rely upon other participants to point out problems or a presenter proactively seeking confirmation from the other participants, but these solutions take time away from productive conversation and reduce an overall quality of the conference call.

It is with respect to these and other general considerations that various aspects have been described. Also, although relatively specific problems have been discussed, it should be understood that the aspects should not be limited to solving the specific problems identified in the background.

### SUMMARY

Aspects of the present disclosure are directed to monitoring quality of a conferencing session.

In one aspect, a method for monitoring audio quality of a conferencing session between a plurality of participant devices is provided. The method comprises: establishing an audio receive channel and an audio send channel for a participant device of the plurality of participant devices, wherein the participant device receives audio signals for the conferencing session on the audio receive channel and transmits audio signals for the conferencing session on the audio send channel; inserting a first audio signal into the audio receive channel for playback by the participant device, the first audio signal having an audio watermark; receiving a second audio signal through the audio send channel, the second audio signal corresponding to a playback period of the first audio signal by the participant device; determining whether the audio watermark is present in the second audio signal; and providing an audio status for the participant device based on whether the audio watermark is present in the second audio signal.

In another aspect, a system for monitoring audio quality of a conferencing session between a plurality of participant devices is provided. The system comprises a conferencing processor and a first memory storing computer-readable instructions that, when executed by the conferencing processor, cause the conferencing processor to establish an audio receive channel and an audio send channel for a participant device of the plurality of participant devices. The participant device receives audio signals for the conferencing session on the audio receive channel and transmits audio signals for the conferencing session on the audio send channel. The system further comprises an audio processor and a second memory storing computer-readable instructions that, when executed by the audio processor, cause the audio processor to: insert a first audio signal into the audio receive channel for playback by the participant device, the first audio signal having an audio watermark; receive a second audio signal through the audio send channel, the second audio signal corresponding to a playback period of the first audio signal by the participant device; determine whether the audio watermark is present in the second audio signal; and provide an audio status for the participant device based on whether the audio watermark is present in the second audio signal.

In yet another aspect, a method for monitoring audio quality of a conferencing session between a plurality of participant devices is provided. The method comprises: establishing an audio send channel for a participant device of the plurality of participant devices, wherein the participant device transmits audio signals for the conferencing session on the audio send channel; receiving an audio signal through the audio send channel, the audio signal corresponding to speech from a user of the participant device; providing at least a portion of the audio signal to a machine learning model to obtain an audio quality score of the audio signal, wherein the machine learning model is trained to evaluate speech quality in audio signals; providing an audio status for the participant device based on the audio quality score.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows a block diagram of an example of a conference system for a conferencing session, according to an example aspect.

FIG. 2 shows a block diagram of a computing device for monitoring audio quality, according to an example aspect.

FIG. 3 shows a diagram of an example notification for a conferencing session, according to an example aspect.

FIG. 4 shows a diagram of another example notification for a conferencing session, according to an example aspect.

FIG. 5 shows a flowchart of an example method of monitoring quality of a conferencing session between a plurality of participant devices, according to an example aspect.

FIG. 6 shows a flowchart of another example method of training a conferencing system, according to an example aspect.

FIG. 7 is a block diagram illustrating example physical components of a computing device with which aspects of the disclosure may be practiced.

FIG. 8 is a simplified block diagram of a mobile computing device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems, or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes various aspects of monitoring audio quality of a conferencing session. In some examples, audio channels are established for a participant device of the conferencing session. For example, the participant device receives audio signals for the conferencing session on an audio receive channel and transmits audio signals for the conferencing session on an audio send channel. The audio receive channel may be provided to a speaker or headset of the participant device, while the audio send channel may receive audio signals from a microphone of the participant device. An audio processor inserts a first audio signal into the audio receive channel for playback by the participant device, where the first audio signal has an audio watermark. The audio watermark may be audible to a user or inaudible, in various scenarios. A second audio signal is received through the audio send channel, where the second audio signal corresponds to a playback period of the first audio signal. The audio processor determines whether the audio watermark is present in the second audio signal. In other words, the audio processor determines whether the audio watermark has been played by the speaker and captured by the microphone. The audio processor may then provide an audio status (e.g., audio system is functional, or not functional) for the participant device based on whether the audio watermark is present in the second audio signal. In some examples, the audio processor is configured to propose remediation strategies for handling identified problems. For example, the system may prompt a user to toggle a physical mute switch on a microphone, switch to a different microphone, etc.

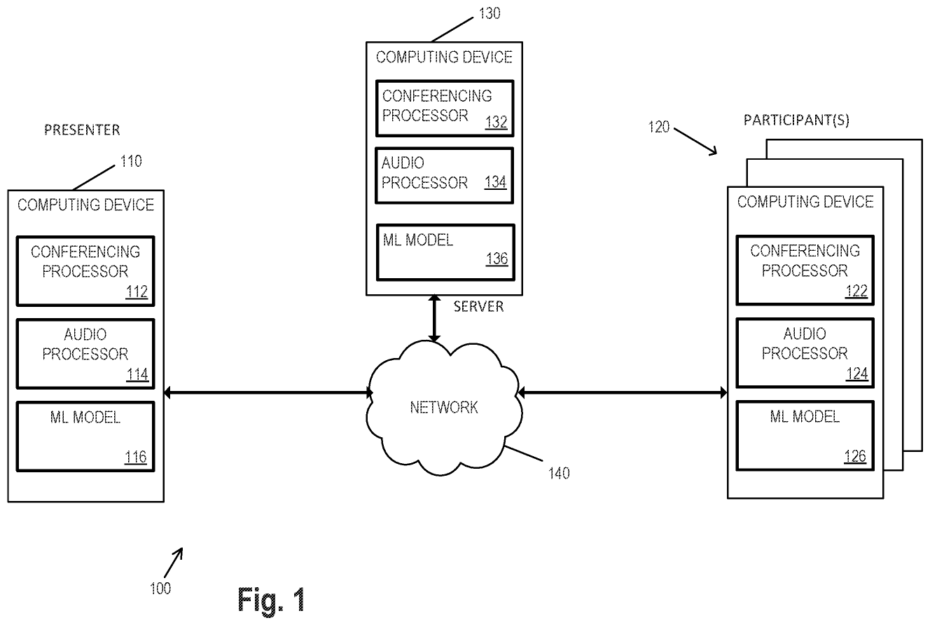

This and many further aspects for a computing device are described herein. For instance, FIG. 1 shows a block diagram of an example of a conference system 100 for a conferencing session, according to an example aspect. The conference system 100 comprises various computing devices 110, 120, and 130 that may be used by participants of a conferencing session, a host of the conferencing session, or by both a host and a participant of the conferencing session. In the example shown in FIG. 1, the computing device 110 is used by a presenter (i.e., one of the participants who is providing media to the other participants, for example, by sharing content, video, or speaking), the computing device 130 is configured as a host for the conferencing session (e.g., by relaying and/or processing data streams among the participants), and one or more instances of computing device 120 are used by participants of the conferencing session.

Computing device 110 may be any type of computing device, including a mobile computer or mobile computing device (e.g., a Microsoft® Surface® device, a laptop computer, a notebook computer, a smartphone, a tablet computer such as an Apple iPad™, a netbook, etc.), or a stationary computing device such as a desktop computer or PC (personal computer). In some aspects, computing device 110 is a cable set-top box, streaming video box, or console gaming device. Computing device 110 may be configured to execute one or more software applications (or “applications”) and/or services and/or manage hardware resources (e.g., processors, memory, etc.), which may be utilized by users of the computing device 110.

The computing device 110 comprises a conferencing processor 112, an audio processor 114, and a machine learning model 116. In some aspects, computing device 120 is similar to computing device 110 (e.g., a mobile computer, laptop, etc.) and comprises a conferencing processor 122, an audio processor 124, and a machine learning model 126, generally corresponding to the conferencing processor 112, the audio processor 114, and the machine learning model 116, respectively.

The computing device 130 may include a conference processor 132, an audio processor 134, and a machine learning model 136, generally corresponding to the conferencing processor 112, the audio processor 114, and the machine learning model 116, respectively. In some examples, the computing device 130 is a network server, cloud server, or other suitable network device. In one such example, the conference processor 132, audio processor 134, and machine learning model 136 act on a “server side” for the conferencing session while the conferencing processors 112 and 122 act on a “client side” for the conferencing session. In some examples, aspects of the audio processors and machine learning models are provided on the server side when participant devices do not include corresponding audio processors or machine learning models (e.g., when a participant connects from a web-based client).

The conferencing processor 112 (and conferencing processor 122) generally provides a conferencing feature to users of the computing device 110. The conferencing feature supports taking part in conferencing sessions, such as conference call sessions, video call sessions, collaborative sessions, etc. The conferencing processor 112 may be implemented as a software program (e.g., Microsoft Teams, Zoom, WebEx), a hardware-based circuit or processor, or a combination thereof. When implemented as a software program, the software program may comprise instructions for a processor (e.g., a microprocessor of a PC) that, when executed by the processor, cause the processor to perform the steps and features described herein. The conferencing processor 112 comprises, or communicates with, one or more of an image sensor or camera, a microphone, speakers, a user interface (e.g., keyboard, mouse, buttons) that facilitate interaction with the conferencing feature. The conferencing processor 112 may be configured to generate one or more data streams having various components, such as an audio component (e.g., an audio signal or transcript of words or sounds within an audio signal), video component (e.g., pixel information for displaying a video), or content sharing component (e.g., information for sharing a document, application, screen, etc.), and transmit the data streams to the computing devices 120 or 130. A user of the computing device 110 may select or provide media for transmission over the data streams, for example, by speaking into the microphone, appearing in front of a webcam, or interacting with a document to be shared with the participants. In some examples, the conferencing processor 112 generates a single data stream that includes the audio component, video component, and shared content component. In other examples, the conferencing processor 112 generates two or more data streams with separate components. As one example, a first data stream includes audio and a second data stream includes video and shared content. As another example, a first data stream includes audio and video and a second data stream includes shared content. In still other examples, a separate data stream is used for each of the audio, video, and shared content components.

Generally, the conferencing processor 112 establishes an audio receive channel and an audio send channel for the computing device 110. The computing device 110 receives audio signals for the conferencing session on the audio receive channel (e.g., for playback on speakers) and transmits audio signals for the conferencing session on the audio send channel (e.g., recorded by a microphone). In some examples, the computing device 110 comprises multiple instances of the microphone or speaker. In these examples, one instance of the microphones may be selected as an enabled microphone device for the conferencing session or otherwise assigned to the conferencing session. Generally, a computing device 110 having a first microphone and a second microphone would have only one microphone assigned to the conferencing session. Accordingly, audio signals would not be captured by the second microphone, or audio signals captured by the second microphone would not be provided to the audio send channel and transmitted to the other participant devices of the conferencing session. In a similar manner, one instance of a speaker may be assigned for playback during the conferencing session. However, in some examples, the audio processor 114 uses an unassigned speaker, an unassigned microphone, or both unassigned speakers and microphones to provide an audio status for the computing device 110, as described below.

The audio processor 114 (and audio processor 124 and 134) is configured to provide an audio status for the computing device 110, in various examples. In some examples, the audio processor 114 (and audio processor 124 and 134) are implemented as a software program (e.g., Microsoft Teams, Zoom, WebEx), a hardware-based circuit or processor, or a combination thereof. When implemented as a software program, the software program may comprise instructions for a processor (e.g., a microprocessor of a PC) that, when executed by the processor, cause the processor to perform the steps and features described herein. In a first example, the audio processor 114 inserts an audio signal having an audio watermark into an audio receive channel and determines whether the audio watermark is present in a second audio signal received through the audio send channel. In other words, the audio processor 114 determines whether the audio watermark has been played by the speaker and captured by the microphone of the computing device 110. Presence of the audio watermark in the signal captured by the microphone generally indicates that the audio system of the computing device 110 is functional (i.e., providing adequate volume, signal quality, etc.). In a second example, the audio processor 114 provides an audio signal from the microphone to a machine learning model to obtain an audio quality score of the audio signal. The audio processor 114 may then provide an audio status for the computing device 110 based on one or both of the presence of the audio watermark and the audio quality score.

To check audio signal quality at a beginning of the conferencing session (or when a new participant joins the conferencing session), in some examples the audio processor 114 (or machine learning model 116) determines a coupling strength between the speaker and microphone when an audio notification sound is played (e.g., a meeting join ring sound played when a participant joins). Other notification sounds may be used in other examples, but generally, any suitable notification sound that is played for the user during the conferencing session may be used by the audio processor 114 for detection through the microphone and determination of a coupling strength (or alternatively, a signal loss level). The coupling strength is measured using a match filter, deep learning model trained to detect the audio notification sound, or other suitable process with a high coupling strength (e.g., 70 dB or more) indicative of an acceptable audio signal quality level while lower coupling strength (e.g., 30 dB). In some examples, the deep learning model provides improved recognition of the notification sound, even in the presence of background noise. The coupling strength is generally significant, even for headsets, which may reduce coupling by approximately 20 dB.

In some examples, the notification sound represents an audio watermark that may be detected by the audio processor 114. In other examples, the audio watermark is a separate audio signal that is combined with an existing audio signal, such as the notification sound, a comfort noise sound, an incoming audio signal or voice from another participant device, or other suitable sound that is provided to the speaker. In some examples, the audio watermark is configured to mimic the existing audio signal (e.g., to sound similar to comfort noise or a notification sound). The audio watermark may be audible to a user or inaudible, in various scenarios. For example, the audio watermark may be audible when it is within an audible range of a typical user (e.g., 50 Hz to 20 kHz), or not audible when it is not within the audible range of the typical user.

To check the audio signal quality during the conferencing session, as opposed to simply at a beginning or when a participant joins, an audio watermark signal may be played on the speaker where the audio watermark is generated to be less noticeable to users, but may be recorded by the microphone and detected by the audio processor 114 or machine learning model 116. The audio watermark signal may be selected to be unobtrusive to other audio signals within the conferencing session. If the audio receive channel and audio send channel are functional, then the watermark signal is detected and the audio processor 114 may generate an indicator in a user interface to show that the audio system is functional.

In various aspects, audio signals for a conferencing session are provided to the machine learning model 116 (or the machine learning models 126 or 136), for example, by the audio processors 114, 124, or 134. Generally, the machine learning model 116 is trained to evaluate speech quality in audio signals and provide a score or other suitable indication as to whether the computing device 110 is properly configured to capture speech. In some examples, the machine learning model 116 is a Non-Intrusive Speech Quality Assessment (NISQA) model that provides a mean opinion score (MOS) for an audio signal (or portion thereof). As long as the MOS is greater than or equal to a suitable value (e.g., 3) then the audio processor 114 may generate an indicator in a user interface to show that the audio system is functional. If the NISQA MOS is less than the suitable value, then the audio processor 114 may generate and display a user facing diagnostic widget to inform the user their speech is distorted, that their microphone is muted (e.g., by a hardware switch), or other suitable notification. The widget may include recommended solutions for improving the quality, such as switching audio devices to one with a higher NISQA or resetting the computing device 110. In some examples, the machine learning model 116 or 126, running on the presenter or participant devices (110, 120), provide a NISQA MOS from a corresponding audio send channel and generally detect device issues that are local to the presenter or participant devices. In other examples, the machine learning model 136, running on the server device (130), provides a NISQA MOS from an audio receive channel and generally detects network issues for the presenter or participant devices (110, 120).

Although separate machine learning models 116, 126, and 136 are shown in FIG. 1 across the computing devices 110, 120, and 130, the machine learning models may be provided at only some of the computing devices, for example, only in the presenter (computing device 110) or only in the server (computing device 130). In some examples, the conference system 100 may include one, two, three, or more machine learning models that are trained for different tasks. In some aspects, the machine learning models are integral with the corresponding audio processor (i.e., audio processor 114 is integral with the machine learning model 116). The machine learning models 116, 126, or 136 may be implemented as a deep learning model, transformer model, species distribution model, or a combination thereof.

Network 140 may comprise one or more networks such as local area networks (LANs), wide area networks (WANs), enterprise networks, the Internet, etc., and may include one or more of wired and/or wireless portions. Computing devices 110, 120, and 140 may include at least one wired or wireless network interface that enables communication with each other (or an intermediate device, such as a Web server or database server) via network 140. Examples of such a network interface include but are not limited to an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, or a near field communication (NFC) interface. Examples of network 140 include a local area network (LAN), a wide area network (WAN), a personal area network (PAN), the Internet, and/or any combination thereof.

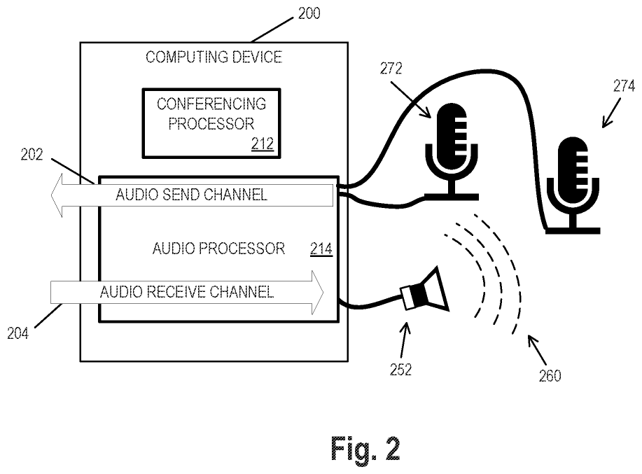

FIG. 2 shows a block diagram of a computing device 200 for monitoring audio quality, according to an example aspect. The computing device 200 may correspond to the computing device 110, the computing device 120, or the computing device 130, in various examples. The computing device 200 comprises a conferencing processor 212 (e.g., corresponding to the conferencing processor 112), an audio processor 214 (e.g., corresponding to the audio processor 114) and one or more audio peripheral devices, such as a speaker 252, a microphone 272, and a microphone 274. The speaker 252 may be an external speaker, embedded speaker (e.g., within a laptop or external display for a computing device), Bluetooth speaker, or any other suitable speaker for playback of an audio signal 260. The microphone 272 may be an external microphone, an embedded microphone (e.g., within a laptop), or other suitable microphone. In some examples, the speaker 252 and microphone 272 are provided as an integral audio interface device, such as a headset, Bluetooth ear buds, or other suitable device. In some examples, the computing device 200 includes multiple instances of the speaker 252 or the microphone 272. In the example shown in FIG. 2, the computing device 200 comprises a microphone 274 as a second instance of a microphone. As an example, the speaker 252 and the microphone 272 may be implemented together as a headset while the microphone 274 is part of a webcam connected with the computing device 200.

The computing device 200 is a participant device in a conferencing session and uses an audio send channel 202 for transmitting audio signals recorded by the microphone 272 or 274 for playback by other participant devices (not shown). The computing device 200 uses an audio receive channel 204 to receive audio signals for the conferencing session for playback on speaker 252. The audio send channel 202 and the audio receive channel 204 may be established by the conferencing processor 212, by the audio processor 214, or a combination thereof.

Generally, the audio processor 214 inserts a first audio signal into the audio receive channel 204 for playback where the first audio signal is generated to have an audio watermark. The audio processor 214 receives a second audio signal through the audio send channel 202 where the second audio signal corresponds to a playback period of the first audio signal by the speaker 252. In other words, the microphone 272 records the second audio signal while the speaker 252 is playing back the first audio signal. The audio processor 214 determines whether the audio watermark is present in the second audio signal and may then provide an audio status for the computing device 200 based on whether the audio watermark is present in the second audio signal.

In some examples, the microphone 272 and speaker 252 are part of a headset that is assigned to the conferencing session and the headset may have a physical mute button, such as a slider switch. Accordingly, the microphone 272 could be muted on a software level (e.g., controlled by a user interface widget that is visible to a user of the computing device 200) or muted on a hardware level (e.g., by the slider switch). In some scenarios, a user may not realize that the microphone 272 has been muted by the slider switch and the user interface widget may show an unmuted microphone. In one example, the audio processor 214 is configured to record a third audio signal using the microphone 274 (e.g., from a webcam or other audio device) that has not been assigned to the conferencing session. The third audio signal may be recorded while the speaker 252 is playing back the first audio signal (or another suitable audio signal). As described above, the audio processor 214 determines whether the audio watermark is present in the third audio signal and may then provide an audio status for the computing device 200 based on whether the audio watermark is present. In some examples, the audio processor 214 provides a notification to the user that the physical mute button has been activated when the audio watermark is detected by the microphone 274 but not by the microphone 272.

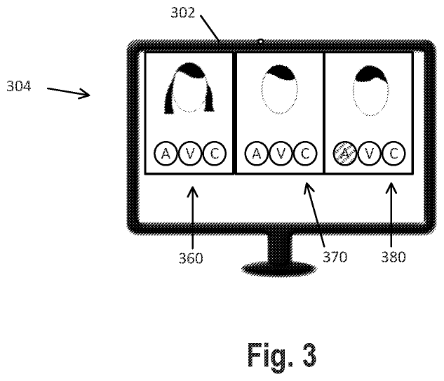

FIG. 3 shows a diagram of example notifications for a conferencing session, according to an example aspect. As shown in FIG. 3, a display 302 of the computing device 110 provides a user interface 304 which may be generated by the conferencing processor 112. The user interface 304 comprises panes 360, 370, and 380 for three participants of a conferencing session. Each of the panes 360, 370, and 380 includes an icon A, V, and C that indicate a status of an audio component, a video component, and a shared content component, respectively, for the conferencing session, along with a video component received by the computing device 110. In FIG. 3, the pane 380 indicates that the audio component of the third participant is inactive by greying out the icon for the audio component. In other examples, the notifications may be provided as colored icons, animations, or other suitable visual notifications. In some examples, the audio processor 112 of the computing device 110 for the third participant sends a notification to the computing devices of the other participants for a similar display notification indicating that the third participant does not have audio.

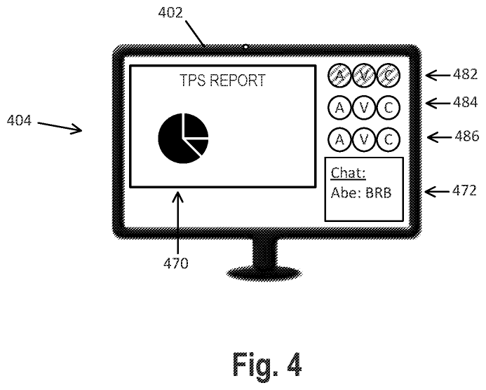

FIG. 4 shows a diagram of another example notification for a conferencing session, according to an example aspect. As shown in FIG. 4, a display 402 of the computing device 110 provides a user interface 404 which may be generated by the conferencing processor 112. The user interface 404 comprises a pane 470 for a shared document (shared content component), a pane 472 for a chat window (shared content component), and respective icon sets 482, 484, and 486 for three participants of the conferencing session. In FIG. 4, the icon set 482 for a first user, “Abe”, has been greyed out to indicate that the user is likely not viewing or listening to the conferencing session. For example, the audio processor 112 may determine that audio watermarks are not being detected from the microphones for the first user. In another example, the icon set 482 provides different visual indicators for different levels of audio quality (e.g., for high, medium, or low levels), such as color-encoded indicators (e.g., green, yellow, red for high, medium, low quality), shape-encoded indicators (e.g., star, circle, triangle), character-encoded indicators (e.g., H, M, L), or other suitable indicators. The icon set 482 may also include a mute status indicator that shows whether a software- or hardware-based mute is enabled or disabled.

In some examples, the audio processor 114 is configured to remove elements from the user interface 304 or 404 when audio from the corresponding participants is being provided and the audio watermarks are being detected.

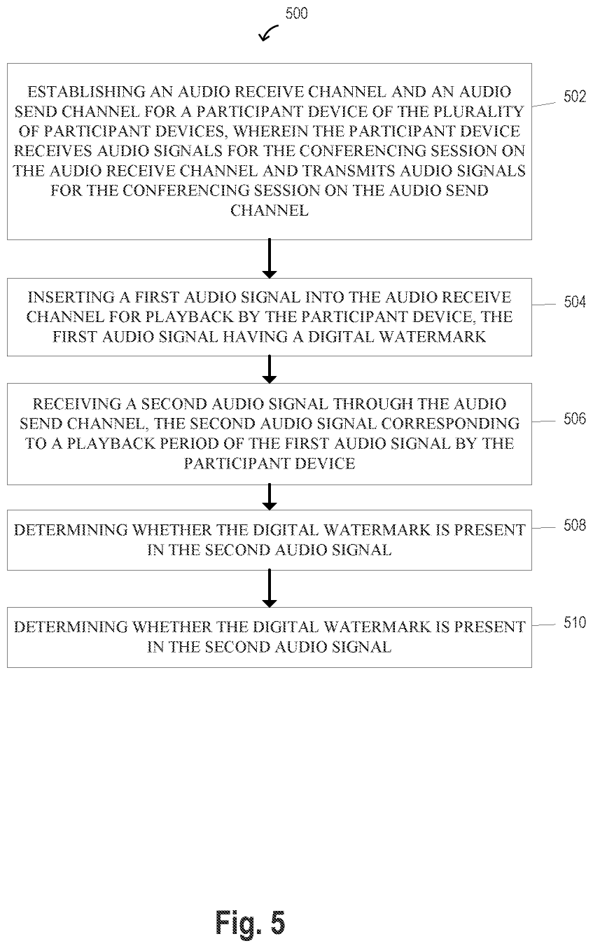

FIG. 5 shows a flowchart of an example method 500 of monitoring audio quality of a conferencing session between a plurality of participant devices, according to an example aspect. Technical processes shown in these figures will be performed automatically unless otherwise indicated. In any given aspect, some steps of a process may be repeated, perhaps with different parameters or data to operate on. Steps in an aspect may also be performed in a different order than the top-to-bottom order that is laid out in FIG. 5. Steps may be performed serially, in a partially overlapping manner, or fully in parallel. Thus, the order in which steps of method 500 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 5 may be performed by the computing device 110 (e.g., via the conferencing processor 112, the audio processor 114, or machine learning model 116), or other suitable computing device.

At step 502, an audio receive channel and an audio send channel are established for a participant device of the plurality of participant devices. The participant device may correspond to the computing device 110, the computing device 120, the computing device 130, or the computing device 200, in various examples. The participant device receives audio signals for the conferencing session on the audio receive channel and transmits audio signals for the conferencing session on the audio send channel.

At step 504, a first audio signal is inserted into the audio receive channel for playback by the participant device. For example, the audio processor 114 generates the first audio signal to include an audio watermark and inserts the first audio signal into the audio receive channel (e.g., audio receive channel 204).

At step 506, a second audio signal is received through the audio send channel. The second audio signal corresponds to a playback period of the first audio signal by the participant device. In one example, the microphone 272 records the second audio signal while the speaker 252 is playing back the first audio signal, as described above.

At step 508, it is determined whether the audio watermark is present in the second audio signal. For example, the audio processor 114 determines whether the audio watermark is present in the second audio signal.

At step 510, an audio status for the participant device is provided based on whether the audio watermark is present in the second audio signal. For example, the audio processor 114 provides a visual indication (e.g., as shown in FIG. 3 or FIG. 4), an audio notification, haptic notification, or other suitable notification to the computing device 110.

In some examples, the audio processor 114 determines whether the audio watermark is present in the second audio signal by providing the second audio signal to a machine learning model configured to detect a presence of the audio watermark. For example, the audio processor 114 provides the second audio signal to the machine learning model 116.

In various examples, the audio processor 114 generates a suitable audio watermark for the first audio signal. In one example, the conferencing session is associated with a meeting join sound that comprises the audio watermark. In other examples, the audio watermark is included in other suitable notification sounds associated with the conferencing session. In still other examples, inserting the first audio signal into the audio receive channel comprises generating the audio watermark as a structured noise pattern. In one such example, generating the audio watermark as the structured noise pattern comprises sampling background noise from a microphone of the participant device and generating the structured noise pattern to simulate the sampled background noise. In another example, generating the audio watermark as the structured noise pattern comprises generating the structured noise pattern to simulate white noise. In yet another example, generating the audio watermark as the structured noise pattern comprises generating the structured noise pattern to simulate comfort noise. By using the structured noise pattern, comfort noise, or background noise for the audio watermark, the audio watermark is effectively concealed from the participants of the conferencing session.

In some examples, the audio watermark is a first audio watermark, the participant device is a first participant device, the audio receive channel is a first audio receive channel, and the audio send channel is a first audio send channel. The method 500 may further comprise generating unique audio watermarks for at least some of the plurality of participant devices, the unique audio watermarks including the first audio watermark and at least a second audio watermark for a second participant device of the plurality of participant devices; establishing a second audio receive channel and a second audio send channel for the second participant device, wherein the second participant device receives respective audio signals for the conferencing session on the second audio receive channel and transmits respective audio signals for the conferencing session on the second audio send channel; inserting a third audio signal into the second audio receive channel for playback by the second participant device, the third audio signal having the second audio watermark; receiving a fourth audio signal through the second audio send channel, the fourth audio signal corresponding to a playback period of the third audio signal by the second participant device; determining whether the second audio watermark is present in the fourth audio signal; and providing an audio status for the second participant device based on whether the second audio watermark is present in the fourth audio signal. In one such example, the audio processor 134 of the computing device 130 (e.g., as a server for the conferencing session) generates unique audio watermarks and provides them to the participant devices. The unique audio watermarks may be distinguishable from each other so that the audio processor 134 can identify which participant devices have provided a response, even when the audio watermarks are part of a same data stream (e.g., a combined audio component having audio components from multiple participant devices). Unique audio watermarks may be generated using a randomized or pseudo-randomized seed, an iterative encoded number, based on a characteristic of a particular user (e.g., a screen name or phone number), characteristics of the participant device (e.g., a network address, geolocation, etc.). By using a unique audio watermark, the server is able to distinguish between participant devices when the watermark is detected.

In some examples, the audio processor 114 generates the audio watermark according to one or more of frequency response parameters of a speaker of the participant device, frequency response parameters of a microphone of the participant device, or a background noise level of the audio send channel. For example, when a speaker has poor playback performance in a certain frequency range (e.g., 20 kHz to 22 kHz), the audio processor 114 may avoid that frequency range when generating the audio watermark to improve a likelihood of detecting the audio watermark. Similarly, if a microphone has poor recording performance outside of a narrow band (approximately 300 Hz to 4 kHz), a wide band (approximately 100 Hz to 8 kHz), or other band, the audio processor 114 may generate the audio watermark to stay within a suitable band to improve a likelihood of detecting the audio watermark.

In some examples, the participant device comprises a first microphone assigned to the conferencing session and a second microphone that is not assigned to the conferencing session. Receiving the second audio signal through the audio send channel may comprise receiving the second audio signal from the second microphone. For example, the audio processor 114 may use the second microphone 274, as described above, or another suitable device (e.g., a headset, alternate microphone).

In some examples, the method 500 further comprises receiving a third audio signal through the audio send channel; determining a Non-Intrusive Speech Quality Assessment (NISQA) score for the third audio signal; and updating the audio status for the participant device based on the NISQA score. For example, while a user is speaking, a third audio signal may be recorded and provided to the machine learning model 116. The machine learning model 116 may provide a NISQA score (MOS) for the third audio signal. As described above, as long as the MOS is greater than or equal to a suitable value (e.g., 3) then the audio processor 114 may generate an indicator in a user interface to show that the audio system is functional. In some examples, providing the third audio signal to the machine learning model 116 is performed only when speech is detected, for example, using a voice activity detector (not shown).

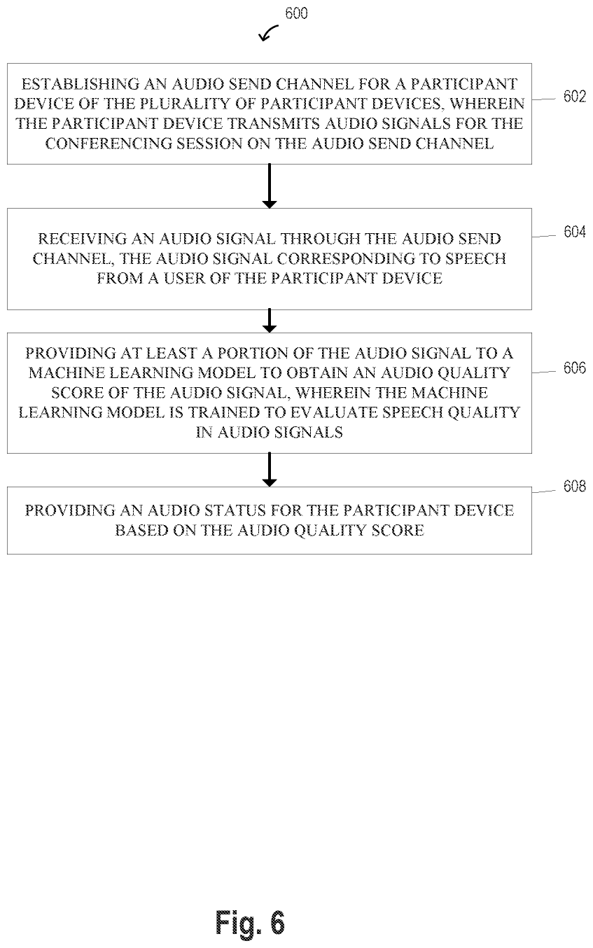

FIG. 6 shows a flowchart of an example method 600 of monitoring audio quality of a conferencing session between a plurality of participant devices, according to an example aspect. Technical processes shown in these figures will be performed automatically unless otherwise indicated. In any given aspect, some steps of a process may be repeated, perhaps with different parameters or data to operate on. Steps in an aspect may also be performed in a different order than the top-to-bottom order that is laid out in FIG. 6. Steps may be performed serially, in a partially overlapping manner, or fully in parallel. Thus, the order in which steps of method 600 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 6 may be performed by the computing device 110 (e.g., via the audio processor 114, machine learning model 116), or other suitable computing device.

Method 600 begins with step 602. At step 602, an audio send channel is established for a participant device of the plurality of participant devices. The participant device transmits audio signals for the conferencing session on the audio send channel.

At step 604, an audio signal is received through the audio send channel, where the audio signal corresponds to speech from a user of the participant device.

At step 606, at least a portion of the audio signal is provided to a machine learning model to obtain an audio quality score of the audio signal. The machine learning model is trained to evaluate speech quality in audio signals. For example, the machine learning model 116, the machine learning model 126, or the machine learning model 136 may be trained as a NISQA model.

At step 608, an audio status for the participant device is provided based on the audio quality score.

In some examples, the audio signal is a first audio signal received via a first microphone of the participant device, the first microphone being assigned to the conferencing session; the audio quality score is a first audio quality score; and the method 600 further comprises: receiving a second audio signal via a second microphone of the participant device, wherein the second microphone is not assigned to the conferencing session and the second audio signal corresponds to the speech from the user of the participant device; providing at least a portion of the second audio signal to the machine learning model to obtain a second audio quality score of the second audio signal; providing, to the user of the participant device, a proposed audio path notification corresponding to the second microphone when the first audio quality score and the second audio quality score indicate that the second microphone provides higher audio quality than the first microphone.

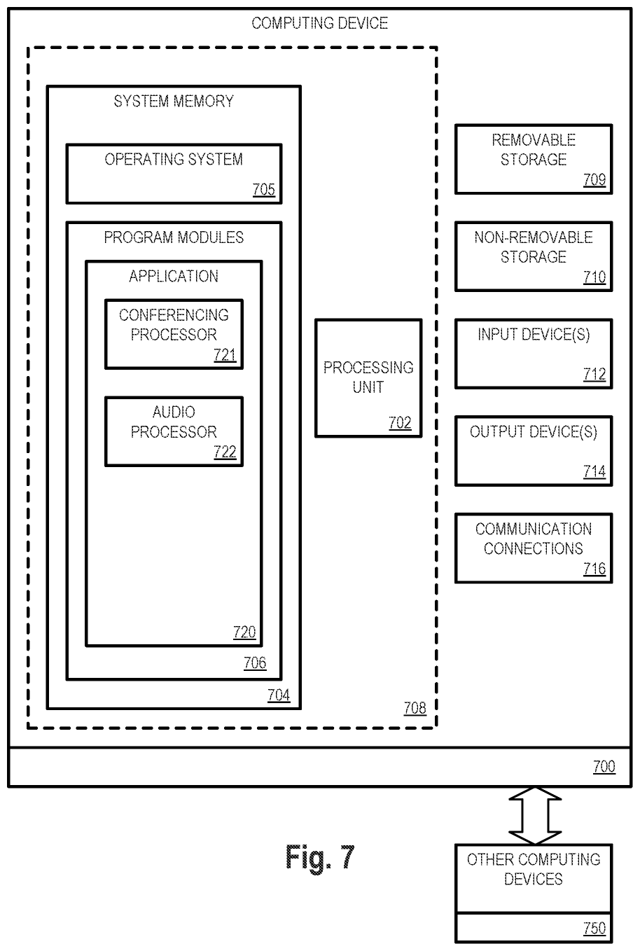

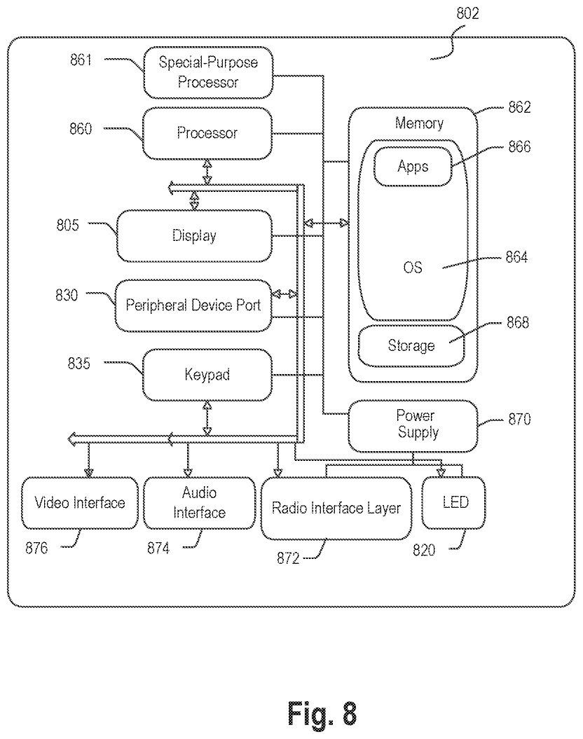

FIGS. 7 and 8 and the associated descriptions provide a discussion of a variety of operating environments in which aspects of the disclosure may be practiced. However, the devices and systems illustrated and discussed with respect to FIGS. 7 and 8 are for purposes of example and illustration and are not limiting of a vast number of computing device configurations that may be utilized for practicing aspects of the disclosure, as described herein.

FIG. 7 is a block diagram illustrating physical components (e.g., hardware) of a computing device 700 with which aspects of the disclosure may be practiced. The computing device components described below may have computer executable instructions for implementing a conference system application 720 on a computing device (e.g., computing device 110, computing device 120, computing device 130), including computer executable instructions for conference system application 720 that can be executed to implement the methods disclosed herein. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running conference system application 720, such as one or more components with regard to FIGS. 1 and 2 and, in particular, conferencing processor 721 (e.g., corresponding to conferencing processor 112, 122, or 132) and audio processor 722 (e.g., corresponding to audio processor 114, 124, or 134).

The operating system 705, for example, may be suitable for controlling the operation of the computing device 700. Furthermore, aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., conference system application 720) may perform processes including, but not limited to, the aspects, as described herein. Other program modules that may be used in accordance with aspects of the present disclosure, and in particular for monitoring quality of a conferencing session, may include conferencing processor 112 and audio processor 722.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 8 illustrates a mobile computing device 800, for example, a mobile telephone, a smart phone, wearable computer (such as a smart watch), a tablet computer, a laptop computer, and the like, with which aspects of the disclosure may be practiced. In some aspects, the client may be a mobile computing device. FIG. 8 is a block diagram illustrating the architecture of one aspect of a mobile computing device. That is, the mobile computing device 800 can incorporate a system (e.g., an architecture) 802 to implement some aspects. In one aspect, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer.

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 825 (e.g., audio transducer 825 illustrated in FIG. 8). In the illustrated example, the visual indicator 820 is a light emitting diode (LED) and the audio transducer 825 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of peripheral device 830 (e.g., on-board camera) to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8 by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 7 and 8 as disclosed herein are described for purposes of illustrating the present methods and systems and are not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for monitoring audio quality of a conferencing session between a plurality of participant devices, the method comprising:
establishing an audio receive channel and an audio send channel for a participant device of the plurality of participant devices, wherein the participant device receives audio signals for the conferencing session on the audio receive channel and transmits audio signals for the conferencing session on the audio send channel;
inserting a first audio signal into the audio receive channel for playback by the participant device, the first audio signal having an audio watermark;
receiving a second audio signal through the audio send channel, the second audio signal corresponding to a playback period of the first audio signal by the participant device;
determining whether the audio watermark is present in the second audio signal; and
providing an audio status for the participant device based on whether the audio watermark is present in the second audio signal.

2. The method of claim 1, wherein determining whether the audio watermark is present in the second audio signal comprises providing the second audio signal to a machine learning model configured to detect a presence of the audio watermark.

3. The method of claim 1, wherein the conferencing session is associated with a meeting join sound that comprises the audio watermark.

4. The method of claim 1, wherein inserting the first audio signal into the audio receive channel comprises generating the audio watermark as a structured noise pattern.

5. The method of claim 4, wherein generating the audio watermark as the structured noise pattern comprises:
sampling background noise from a microphone of the participant device; and
generating the structured noise pattern to simulate the sampled background noise.

6. The method of claim 4, wherein generating the audio watermark as the structured noise pattern comprises generating the structured noise pattern to simulate white noise.

7. The method of claim 4, wherein generating the audio watermark as the structured noise pattern comprises generating the structured noise pattern to simulate comfort noise.

8. The method of claim 1, wherein:
the audio watermark is a first audio watermark, the participant device is a first participant device, the audio receive channel is a first audio receive channel, and the audio send channel is a first audio send channel;
the method further comprises:
generating unique audio watermarks for at least some of the plurality of participant devices, the unique audio watermarks including the first audio watermark and at least a second audio watermark for a second participant device of the plurality of participant devices;
establishing a second audio receive channel and a second audio send channel for the second participant device, wherein the second participant device receives respective audio signals for the conferencing session on the second audio receive channel and transmits respective audio signals for the conferencing session on the second audio send channel;
inserting a third audio signal into the second audio receive channel for playback by the second participant device, the third audio signal having the second audio watermark;
receiving a fourth audio signal through the second audio send channel, the fourth audio signal corresponding to a playback period of the third audio signal by the second participant device;
determining whether the second audio watermark is present in the fourth audio signal; and
providing an audio status for the second participant device based on whether the second audio watermark is present in the fourth audio signal.

9. The method of claim 1, the method further comprising:
generating the audio watermark according to one or more of frequency response parameters of a speaker of the participant device, frequency response parameters of a microphone of the participant device, or a background noise level of the audio send channel.

10. The method of claim 1, wherein:
the participant device comprises a first microphone assigned to the conferencing session and a second microphone that is not assigned to the conferencing session; and
receiving the second audio signal through the audio send channel comprises receiving the second audio signal from the second microphone.

11. The method of claim 1, wherein the method further comprises:
receiving a third audio signal through the audio send channel;
determining a Non-Intrusive Speech Quality Assessment (NISQA) score for the third audio signal; and
updating the audio status for the participant device based on the NISQA score.

12. A system for monitoring audio quality of a conferencing session between a plurality of participant devices, the system comprising:
a conferencing processor and a first memory storing computer-readable instructions that, when executed by the conferencing processor, cause the conferencing processor to establish an audio receive channel and an audio send channel for a participant device of the plurality of participant devices, wherein the participant device receives audio signals for the conferencing session on the audio receive channel and transmits audio signals for the conferencing session on the audio send channel;
an audio processor and a second memory storing computer-readable instructions that, when executed by the audio processor, cause the audio processor to:
insert a first audio signal into the audio receive channel for playback by the participant device, the first audio signal having an audio watermark;
receive a second audio signal through the audio send channel, the second audio signal corresponding to a playback period of the first audio signal by the participant device;
determine whether the audio watermark is present in the second audio signal; and
provide an audio status for the participant device based on whether the audio watermark is present in the second audio signal.

13. The system of claim 12, the system further comprising a conferencing server, wherein the conferencing server comprises the conferencing processor and the audio processor.

14. The system of claim 13, wherein the audio watermark is a first audio watermark, the participant device is a first participant device, the audio receive channel is a first audio receive channel, and the audio send channel is a first audio send channel;
wherein the first memory stores computer-readable instructions that, when executed by the conferencing processor, cause the conferencing processor to:
establish a second audio receive channel and a second audio send channel for a second participant device of the plurality of participant devices, wherein the second participant device receives respective audio signals for the conferencing session on the second audio receive channel and transmits respective audio signals for the conferencing session on the second audio send channel;
wherein the second memory stores computer-readable instructions that, when executed by the audio processor, cause the audio processor to:
generate unique audio watermarks for at least some of the plurality of participant devices, the unique audio watermarks including the first audio watermark and at least a second audio watermark for the second participant device of the plurality of participant devices;
insert a third audio signal into the second audio receive channel for playback by the second participant device, the third audio signal having the second audio watermark;
receive a fourth audio signal through the second audio send channel, the fourth audio signal corresponding to a playback period of the third audio signal by the second participant device;
determine whether the second audio watermark is present in the fourth audio signal; and
provide an audio status for the second participant device based on whether the second audio watermark is present in the fourth audio signal.

15. The system of claim 14, wherein the second memory stores computer-readable instructions that, when executed by the audio processor, cause the audio processor to:
provide the audio status for the second participant device to the first participant device; and
provide the audio status for the first participant device to the second participant device.

16. The system of claim 12, the system further comprising the participant device, wherein the participant device comprises the conferencing processor and the audio processor.

17. A method for monitoring audio quality of a conferencing session between a plurality of participant devices, the method comprising:
establishing an audio send channel for a participant device of the plurality of participant devices, wherein the participant device transmits audio signals for the conferencing session on the audio send channel;
receiving an audio signal through the audio send channel, the audio signal corresponding to speech from a user of the participant device;
providing at least a portion of the audio signal to a machine learning model to obtain an audio quality score of the audio signal, wherein the machine learning model is trained to evaluate speech quality in audio signals; and
providing an audio status for the participant device based on the audio quality score.

18. The method of claim 17, wherein:
the audio signal is a first audio signal received via a first microphone of the participant device, the first microphone being assigned to the conferencing session;
the audio quality score is a first audio quality score;
the method further comprises:
receiving a second audio signal via a second microphone of the participant device, wherein the second microphone is not assigned to the conferencing session and the second audio signal corresponds to the speech from the user of the participant device;
providing at least a portion of the second audio signal to the machine learning model to obtain a second audio quality score of the second audio signal;
providing, to the user of the participant device, a proposed audio path notification corresponding to the second microphone when the first audio quality score and the second audio quality score indicate that the second microphone provides higher audio quality than the first microphone.

19. The method of claim 17, wherein the machine learning model is a non-intrusive speech quality assessment model.

20. The method of claim 17, wherein the participant device comprises the non-intrusive speech quality assessment model.
